(19) United States
(12) Patent Application Publication
(10) Pub. No.: US 2007/0029170 A1
(43) Pub. Date: Feb. 8, 2007

(54) Rolling conveyor support

(75) Inventor: Daniel S. Anagnost, Hawley, MN (US)

Correspondence Address: DICKE, BILLIG & CZAJA, PLLC, Fifth Street Towers, Suite 2250, 100 South Fifth Street, Minneapolis, MN, 55402, US

(73) Assignee: Superior Industries, LLC, Morris, MN (US)

(21) Appl. No.: 11/196,219

(22) Filed: Aug. 3, 2005

(51) Int. Cl. B65G 21/14

(52) U.S. Cl. 198/588; 198/313; 198/825

(57) ABSTRACT

A rolling support for a stackable conveyor system, having a first conveying section and a second conveying section storable atop the first conveying section, comprises an axle, and first and second roller assemblies mounted on opposite ends of the axle. The axle includes a centrally mounted pivot shaft that extends normal to the axle for a pivotal connection of the axle near a rear end of a frame of the second conveying section. The first and second roller assemblies each include one or more rollers that are configured to mate with a pair of rails formed on elongate beams associated with a frame of the first conveying section. The rolling support supports the rear end of the second conveying section on the rails, with the front end and middle portion of the second conveying section frictionally supported on the rail. The rolling support allows the second conveying section to extend relative to the first conveying section once the front end of the second conveying section is elevated from the rails. The pivotal connection of the axle to the frame of the second conveying section allows the front end of the second conveying section a range of off-axis travel as the second conveying section is extended while maintaining connection of the first and second roller assemblies with the rails. Stop members are provided on the first and second rolling assemblies to engage stops provided at each end of the elongate beams to prevent the rolling support from extending past the ends of the elongate beams.

### CROSS-REFERENCE TO RELATED APPLICATION(S)

None.

### BACKGROUND OF THE INVENTION

The present invention relates to a conveyor system, and more particularly, to a conveyor system having multiple conveying sections that may be stored and/or transported in a stacked configuration and then assembled to form an elongate material conveying system.

Conveyor systems are commonly used whenever there is a need to transport materials from one location to another. For example, the agricultural and aggregate industries use conveyor systems to transport and stockpile various materials. Several types of conveyor systems exist, including those that are fixed at a location, such as those used in a baggage handling system at an airport, and those that are transportable, such as those used for transporting aggregate at a mining site. The choice of conveyor type will depend on many factors, including the material being transported and the length of time a conveyor system is needed at a specific location.

When bulk material handling at a particular site is only temporary, it is often desirable to use transportable conveyor systems. These transportable systems are available in various designs. One common example of a transportable conveyor system utilizes conveyor sections that are stackable. Transportable, stackable conveyor systems typically consist of a plurality of individual conveyor sections stacked one on top of another on a flat semi-tractor trailer. Generally, if a transportable conveyor system of significant length is desired, it is necessary to transport numerous conveyor sections on one or more trailers. Each conveyor section has to be unloaded individually from the trailer, and then set-up and connected at a desired location. This requires a crane, which is not typically found on many job sites. When the conveyor system is no longer needed, the conveyor sections must be taken apart and re-loaded by crane onto a trailer.

Conveyor manufacturers have attempted to produce transportable conveyor systems that may be used at a job site on a temporary basis and that are easily set-up and taken down. Although there are several design options for transportable conveyor systems containing multiple conveyor sections, there exists a need for other alternatives, preferably ones that are faster, simpler, and less costly to both set-up and tear-down.

### BRIEF SUMMARY OF THE INVENTION

The present invention is directed toward a rolling support that allows for simpler and easier set-up and take-down of stackable conveyor systems of the variety that comprise a first conveyor section having an elongate frame comprised of a first pair of spaced beams configured to define a rail system, and a second conveyor section configured for engaging the rail system of the first conveyor section. The second conveyor section has an elongate frame comprising a second pair of spaced beams and a cross support mounted between the second pair of spaced beams near one end of the second conveyor section. The rolling support is comprised of an axle that has a first end, a second end and a longitudinal axis. A pivot shaft is connected to the axle between the first and second ends and extends normal to the longitudinal axis of the axle. The pivot shaft is configured for pivotal connection to the cross support. A first roller assembly is rotatably connected to the first end of the axle and comprises a first roller configured for a rolling engagement with a first rail of the rail system. A second roller assembly is rotatably connected to the second end of the axle and comprises a second roller configured for a rolling engagement with a second rail of the rail system.

### BRIEF DESCRIPTION OF THE DRAWINGS

FIG. 1 is a side view of one embodiment of a stackable conveyor system of the present invention.

FIG. 2 is an enlarged broken side view of the conveyor system of FIG. 1.

FIG. 3 shows an exploded view of one embodiment of a rolling conveyor support of the present invention.

FIG. 4 is a cross-sectional view of the stackable conveyor system of FIG. 1 taken along line 4-4.

FIG. 5 is a cross-sectional view of the stackable conveyor system of FIG. 1 taken along line 5-5.

FIG. 5A is an enlarged perspective view of a fixed support of the upper conveyor section of stackable conveyor system FIG. 1.

FIGS. 6-10 are sequential views of the method of deploying the stackable conveyor system of the present invention.

### DETAILED DESCRIPTION

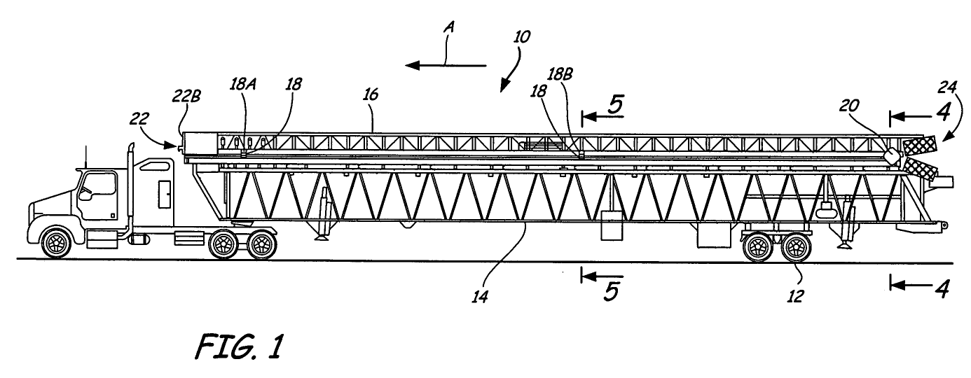

FIG. 1 is a side view of one embodiment of a stackable conveyor system 10 which may be fitted with an axle/wheel assembly 12 for transportation by a truck. Conveyor system 10 comprises a first conveyor section 14, shown in FIG. 1 as being located nearest to the ground, and a second conveyor section 16 positioned atop of the first conveyor section 14. As shown in FIG. 1, in the stacked position, the conveyor system 10 has a front end 22 and a rear end 24. Each conveyor section 14, 16 is comprised of a conventional motor-actuated conveyor belt supported on idler rollers carried by a frame. The essence of the invention is configuring the upper extent of the frame of the first conveyor section 14 with a rail system that receives fixed supports 18 and a rolling support 20 secured to the lower extent of the frame of second conveyor section 16. As shown in FIG. 1, fixed supports 18A are located on second conveyor section 16 generally near the front end 22 of conveyor system 10 and fixed supports 18B are located on second conveyor section 16 generally midway between front end 22 and rear end 24 of conveyor system 10. Rolling conveyor support 20, which includes one or more rollers mateable with the rail system of the first conveyor section 14 is located generally near the rear end 24 of second conveyor section 16. With second conveyor section 16 supported in this manner, the second conveyor section 16 can be stored or transported sitting atop the first conveyor section 14 and easily deployed in the direction of arrow A by elevating the front end 22B of the second conveyor section 16, such as with the bucket of a front end loader typically found on an excavation work site, until fixed supports 18A and 18B are no longer in contact with the rails. The front end loader then is driven in reverse allowing the second conveyor section 16 to roll on the rail system in the direction of arrow A via the rolling support 20.

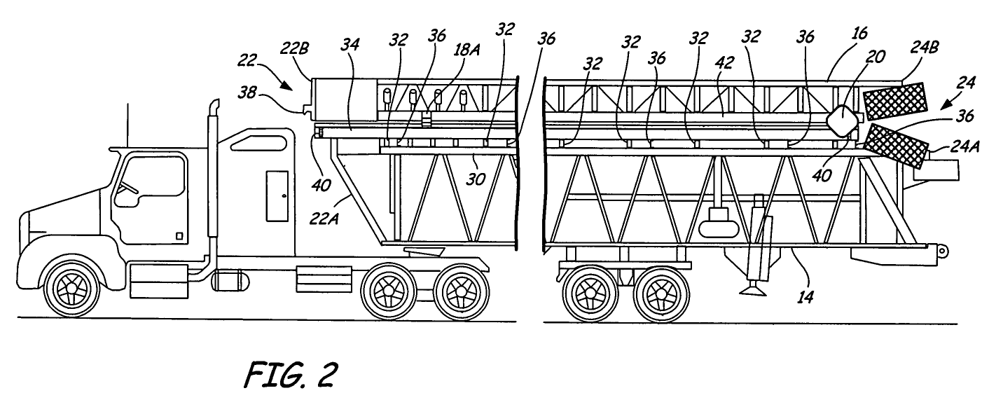

FIG. 2 is an enlarged broken side view of conveyor system 10 of FIG. 1. First conveyor section 14 comprises a rectilinear frame which at essence includes a pair of elongated support beams 30 that extend generally from front end 22A to rear end 24A, of which only one support beam on the left side of first conveyor section 14 is shown in the side view of FIG. 2. Support beams 30 provide support for a plurality of idler rollers (not shown) mounted to idler roller supports 32. For conveyor sections configured like first conveyor section 14, the idler rollers extend above support beams 30. To accommodate and hold the second conveyor section 16, a pair of additional elongate beams 34 which also extend generally from front end 22A to rear end 24A are supported above support beams 30 by a plurality of cross supports 36 connected to support beams 30. In one embodiment, cross supports 36 are steel channels approximately 61⅜ inches in length, with a height of 6 inches, and are welded to support beams 30 at approximately 8 foot intervals. Beams 34 have a height in combination with cross supports 36 sufficient to provide clearance over the idler rollers carried by first conveyor section 14 and thereby to carry second conveyor section 16. In one embodiment, beams 34 are steel I-beams approximately 79 feet 7 inches in length, with a height of 10 inches. The upper surface of beams 34 are configured with a rail surface to allow rolling conveyor support 20 to travel along beams 34 for deployment or storage of second conveyor section 16 relative to the first conveyor section 14.

Second conveyor section 16 also comprises a rectilinear frame comprising a pair of elongate support beams 42 which have a length generally similar to beams 34. Connected to support beams 42 are the fixed supports 18, of which only one of supports 18A is shown in FIG. 2, and the rolling conveyor support 20. To facilitate the deployment or storage of the second conveyor section 16, the front end 22B of second conveyor section 16 is provided with a projecting member, e.g., hook 38 or equivalent structure accessible to the bucket of a front end loader. To control the range of travel of the rolling conveyor support 20 along the rail surface of beams 34, stops 40 are provided at opposite ends of beams 34 to engage rolling conveyor support 20 and to prevent the rolling support 20 from rolling off of the rail system.

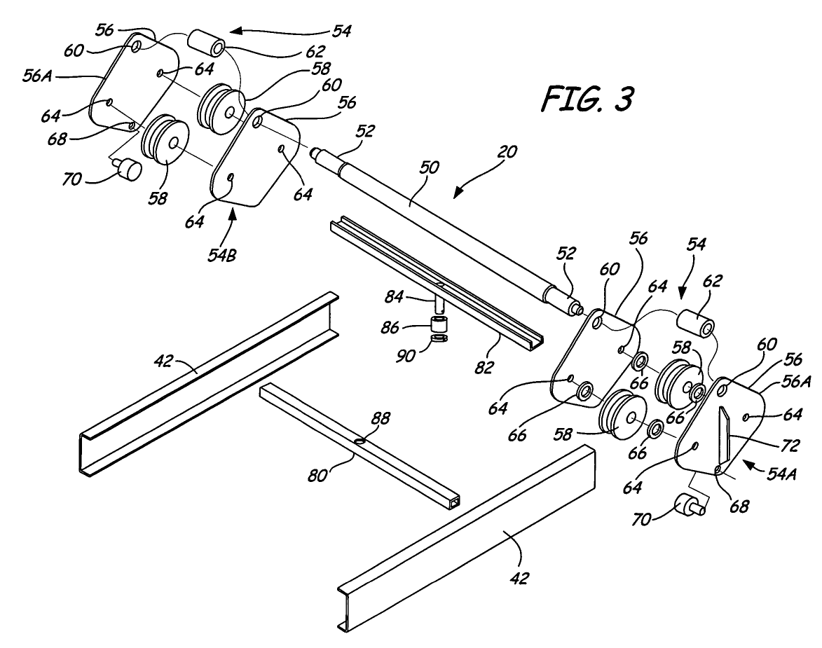

FIG. 3 is an exploded view of one embodiment of a rolling conveyor support 20 of the present invention. As shown in FIG. 3, rolling support 20 includes an axle 50 with opposing end portions 52 of a reduced out diameter for receiving rolling assemblies 54. In one embodiment, each rolling assembly 54 is comprised of a pair of metal plates 56 for carrying rollers 58 therebetween. Plates 56 are generally square and are provided with complimentary holes 60 in an upper corner of each plate. Positioned within holes 60 of each pair of plates 56 and welded thereto is a cylindrical bushing 62 which has a bore sized to be positioned over end portion 52 of the axle 50. Bushings 62 support each rolling assembly 54 on the end portion 52 of axle 50 and permit a rotational movement of each rolling assembly 54 about the longitudinal axis of axle 50, which allows the front end 22B of the second conveyor section 16 to be raised and/or lowered relative to the first conveyor section 14.

Each plate 56 is further provided with a pair of spaced holes 64 near opposite corners of plates 56 and below holes 60 for mounting a pair of rollers 58 between plates 56. As shown in FIG. 3, one of rolling assemblies 54, identified as rolling assembly 54A, is further provided with spacers 66 between each plate 56 and each side of rollers 58 to keep rollers 58 centered between plates 54. Rollers 58 are secured between plates 54 by a pin-type axle (not shown). In an alternative embodiment, a single roller 58 may be mounted directly to the end portions 52 of axle 50, thereby eliminating the plate/bushing construction of rolling assembly 54.

The outer-most plate 56A is provided with an additional hole 68 in the lower corner for mounting a stop member 70. In one embodiment, stop member 70 comprises a bolt or similar structure that is fit through hole 68 and secured, such as with a nut. Stop member 70 extends from plate 56A toward rollers 58 and functions in part in engaging stops 40 (shown in FIG. 2) to prevent rolling support 20 from rolling off of the rail formed on beams 34. A metal reinforcing rib is also secured to the outward facing surface of plate 56A such as by welding.

Axle 50 is supported on a metal cross-support 80 that is connected by welding between support beams 42 of the second conveyor section 16. In one embodiment, axle 50 is secured to a U-shaped metal channel 82 comprised of a base and a pair of generally parallel walls extending from the base, with the axle positioned between the pair of walls. The base of the U-shaped metal channel 82 is provided with a medially positioned pivot shaft 84 that extends in a direction opposite the pair of walls of the U-shaped channel. A cylindrical bushing 86 is positioned over shaft 84 and is sized to fit within a complimentary bore 88 through cross support 80. A nut 90 secures pivot shaft 84 relative to cross support 80 and allows a pivoting movement of rolling support 20 about the pivot shaft 84. In other embodiments, the pivot shaft 84 can be directly secured to axle 50, such as by welding.

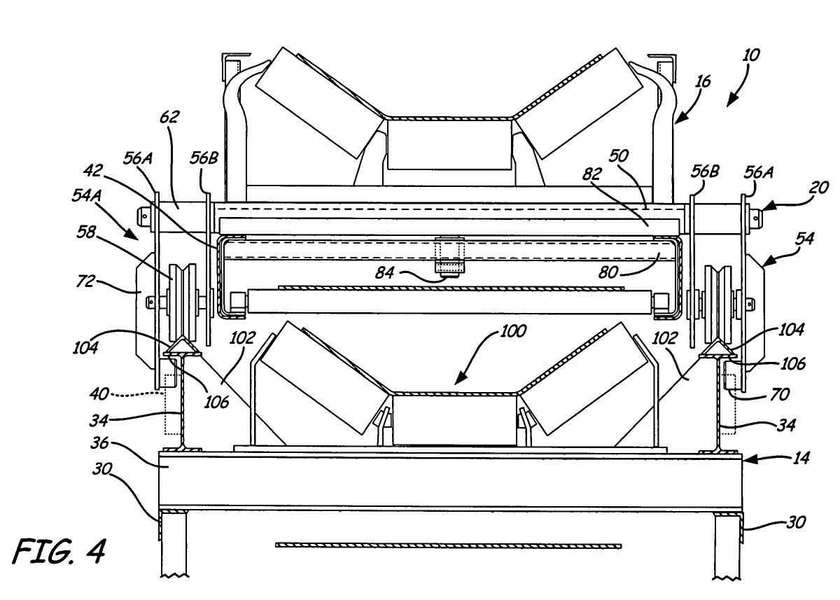

FIG. 4 is a cross-sectional view of the stackable conveyor system 10 taken along line 4-4 of FIG. 1. As shown in FIG. 4, the first conveyor section 14 carries an idler roller system 100 above support beams 30. Space for storing second conveyor section 16 is created by connecting cross supports 36 across support beams 30 and securing beams 34 to cross supports 36. Beams 34 may be further supported by welding gussets 102 between beams 34 and cross supports 36.

To form a rail for rollers 58, the top of the I-beam forming beam 34 is fitted with angle iron 104 along the length of beam 34, with the free ends of the angle iron 104 being welded to beam 34 and the apex of the angle iron oriented towards rollers 58. Rollers 58 are formed with a complimentary V-shaped circumferential groove that positively registers with the apex of the rail for a secure rolling connection of rollers 58 to the rail. Stops 40 (shown in phantom) extend from beams 34 and are secured to the beam by either bolting or welding. Stops 40 engage stop member 70 and prevent rolling support from rolling past the ends of beams 34. As shown in FIG. 4, stop members 70 also extend beneath the upper cross wall 106 of beam 34 and serve to prevent rolling support 20 from being lifted inadvertantly off the rails.

As further shown in FIG. 4, the width of the second conveyor section 16 defined by support beams 42 is less than the width of beams 34. The cross support 80 is secured to the support beams 42 of the second conveyor section 16 so as to be near the top of support beams 42, as oriented in FIG. 4, with the U-shaped channel 82 and axle 50 positioned above support beams 42. Axle 50 has a length approximating the width of support beams 30 and rolling assemblies 54 are positioned on axle 50 such that inner plates 56B of each rolling assembly 54 are spaced from support beams 42 with rollers 58 aligned with the rail formed by angle iron 104. This configuration allows rolling support 20 to pivot about the pivot shaft 84 in the event the front end 22B of the second conveyor section 16 becomes misaligned in the course of being deployed by a front end loader. Rollers 58 of rolling assembly 54A are allowed to float on their axles between plates 56A and 56B to accommodate slight variances in the spacing of rails of beams 34 along the length of the first conveyor section 14.

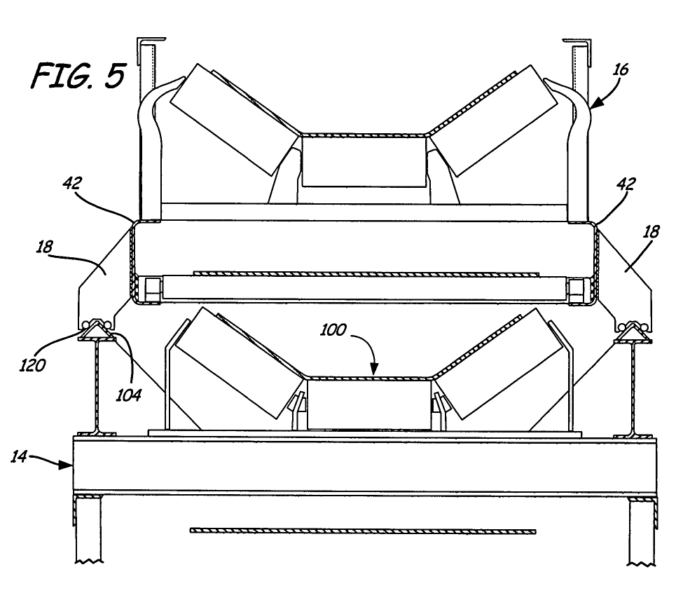

FIG. 5 is a cross-sectional view of the stackable conveyor system 10 of FIG. 1 taken along line 5-5 to better illustrate the fixed supports 18. As shown in FIG. 5, each fixed support 18 is comprised of a laterally extending metal projection that is welded to support beams 42 of the second conveyor section 16. The lower end 120 of each fixed support 18 is formed with a V-shaped notch that mates with and frictionally engages the angle iron rail 104. Fixed supports 18 are dimensioned to space support beams 42 of second conveyor section 16 above the idler roller assembly 100 of the first conveyor section 14. As shown in FIG. 5A, in one embodiment, fixed supports 18 have a box-like construction formed by forming and welding plates of steel to achieve the necessary spacing of the second conveyor section 16 above first conveyor section 14. Metal rods 122 are welded within the V-shaped notch in the lower end 120 at opposite sides of fixed support 18 to provide a support surface for fixed support 18 across the width of the support.

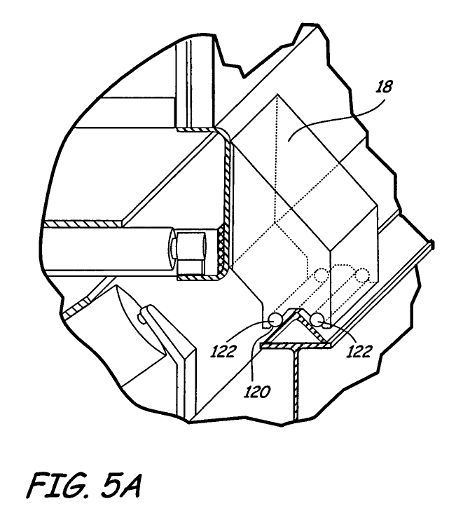

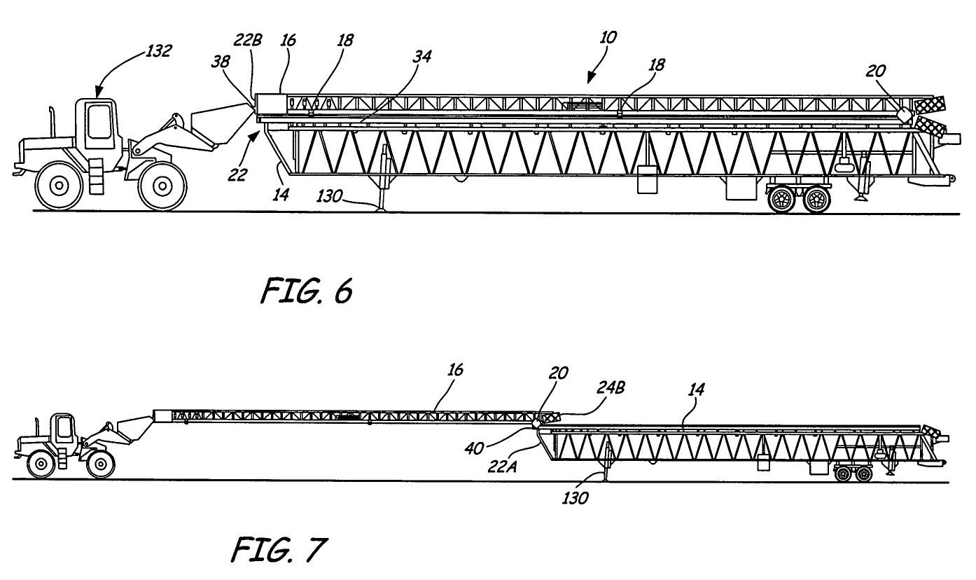

The sequence of deploying the second conveyor section 16 from its stacked position atop conveyor section 14 is demonstrated in FIGS. 6-10. FIG. 6 is a side view of the stackable conveyor system 10 with the truck removed and the front end 22 supported by an adjustable front support stand 130 mounted to first conveyor section 14 such that conveyor system 10 is generally level with the ground surface. To extend second conveyor section 16, a lifting device, e.g., front end loader 132, or similar piece of equipment, is positioned with the bucket facing the front end 22. The bucket is maneuvered to a position beneath hook 38 and the bucket is then raised by the operator of the front end loader until fixed supports 18 are no longer in contact with the rail of beam 34. At this point, the second conveyor section 16 is supported on the rail by the rolling support 20.

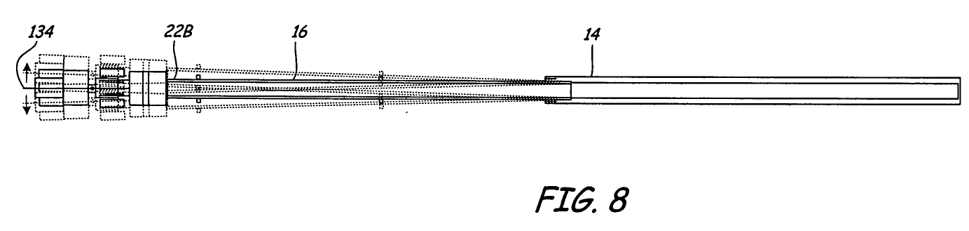

As shown in FIG. 7, with the second conveyor section 16 supported on rolling support 20, the front end loader is operated in reverse until rolling support 20 engages the stop 40 on the first conveyor section 14 near front end 22A of conveyor section 14. The rolling support 20 is located on the second conveyor section 16 so that when rolling support 20 engages stop 40, the rear end 24B of second conveyor section 16 overlaps the front end 22A of first conveyor section 14. As shown in the top diagrammatic view of FIG. 8, the pivotal connection of the rolling support 20 about the pivot shaft 84 (shown in FIG. 4) enables the front end 22B of the second conveyor section 16 to move laterally relative to the longitudinal axis 134 of the conveyor system 10 in the event that the front end loader strays relative to longitudinal axis 134 in the course of backing away from the first conveyor section 14. In one embodiment, the front end 22B of second conveyor section 16 is able to rotate up to five degrees either side of the longitudinal axis 134.

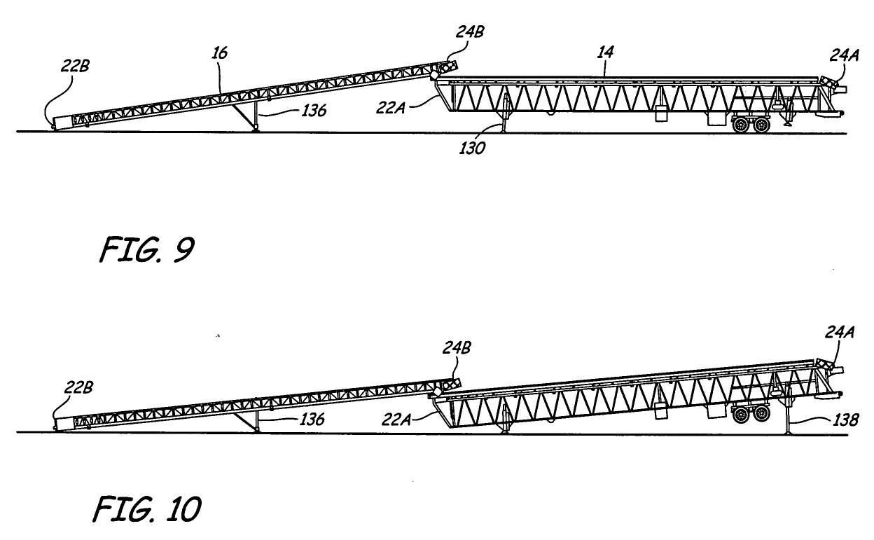

As shown in FIG. 9, once the second conveyor section 16 has been fully extended, the front end loader lowers the front end 22B of the second conveyor section to the ground, the rear end 24B of the second conveyor section 16 pivoting about the pivotal connection of bushings 62 to axle ends 52. An adjustable support stand 136 mounted on second conveyor section 16 is then lowered to engage the ground to support a midsection of the second conveyor section 16. As shown in FIG. 10, the first conveyor section 14 may then be set to a desired conveying angle by adjusting the front support stand 130 and a rear support stand 138 mounted toward the rear end 24A of first conveyor section 14.

When conveyor system 10 is in the fully set-up position shown in FIG. 10, first conveyor section 14 and second conveyor section 16 form one continuous conveyor system. As such, materials deposited on front end 22B of second conveyor section 16 will be transported to second end 24A of first conveyor section 14. Take-down of portable conveyor system 10 is performed in the reverse order of the set-up procedure indicated above.

The stackable conveyor system of the present invention is a simple and economical way of storing and/or transporting multiple conveyor sections in a stacked configuration and deploying the multiple conveyor sections to form an elongate conveyor system for the transportation of materials over a distance. A rail system is formed on a pair of elongate beams located on opposite sides of a first conveyor section. A second conveyor section is provided with a plurality of spaced fixed supports that mate with the rail to store second conveyor section atop of the first conveyor section. In one embodiment, the fixed supports are positioned to be near a front end and a mid section of the second conveyor section. A rolling support is mounted to the second conveyor section near a rear end of the second conveyor section. The rolling support includes a rolling assembly on each side of the second conveyor section that is comprised of one or more rollers that mate with the rails of the rail system. In one embodiment, the rollers of each rolling assembly are carried between a pair of plates supported by a bushing that mounts on the respective end of an axle spanning the second conveyor section. The bushing of each rolling assembly allows the front end of the second conveyor section to be raised and lowered relative to the first conveyor section and yet maintain the rollers on the rail system. The axle is pivotally mounted to the second conveyor section to allow the front end of the second conveyor section a range of lateral movement and yet maintain the rollers securely on the rails system.

Although the present invention has been described with reference to preferred embodiments, workers skilled in the art will recognize that changes may be made in form and detail without departing from the spirit and scope of the invention.

1. A rolling support for a stackable conveyor system including a first conveyor section having an elongate frame comprising a first pair of spaced beams configured to define a rail system and a second conveyor section configured for engaging the rail system of the first conveyor section and having an elongate frame comprising a second pair of spaced beams and a cross support mounted between the second pair of spaced beams near one end of the second conveyor section, the rolling support comprising:
an axle having a first end, a second end, a longitudinal axis and a pivot shaft connected to the axle between the first and second ends and extending normal to the longitudinal axis of the axle, the pivot shaft configured for pivotal connection to the cross support;
a first roller assembly rotatably connected to the first end of the axle and comprising a first roller configured for a rolling engagement with a first rail of the rail system; and
a second roller assembly rotatably connected to the second end of the axle and comprising a second roller configured for a rolling engagement with a second rail of the rail system.

2. The rolling support of claim 1 wherein the axle further comprises a U-shaped channel having a base wall and a pair of generally parallel side walls connected to the base wall, the axle connected between the side walls, wherein the pivot shaft extends from the base in a direction opposite the pair of side walls.

3. The rolling support of claim 1 wherein the first roller assembly and second roller assembly each comprises:
a pair of spaced plates;
a cylindrical pivot bushing secured between the pair of plates, the pivot bushing being positioned over one of the first and second ends of the axle;
a pair of rollers spaced from the cylindrical bushing and rotationally connected between the pair of plates.

4. The rolling support of claim 3 wherein each roller of the pair of rollers has a width that is less than a spacing of the pair of plates.

5. The rolling support of claim 4 wherein the first roller assembly further comprises spacers between the pair of rollers and each plate of the pair of plates, the spacers centering each roller of the pair of rollers between the pair of plates.

6. The rolling support of claim 5 wherein each roller of the first and second roller assemblies is configured with a circumferential groove.

7. The rolling support of claim 3 wherein the first and second roller assemblies further comprise a stop member connected to a first plate of each pair of plates and extending toward the pair of rollers, wherein the rollers are positioned between the pivot bushing and the stop member.

8. A stackable conveyor system comprising:
a first conveyor section having a length, the first conveyor section including an elongate frame and an endless conveyor belt system carried by the frame along the length of the first conveyor section, the frame comprising a pair of elongate spaced beams extending along the length, each beam of the pair of beams configured to define a rail;
a second conveyor section having a first end, a second end and a length, the second conveyor section including an elongate frame and an endless conveyor belt system carried by the frame along the length of the second conveyor section, the frame of the second conveyor section comprising:
a pair of spaced beams;
a cross support connected to and extending between the pair of space beams of the second conveyor section near the first end of the second conveyor section; and
a rolling support comprising an axle having a first end and a second end, the axle being pivotally connected to the cross support, the first and second ends configured with rollers for rotational engagement with the rails of the pair of beams of the first conveyor section.

9. The stackable conveyor system of claim 8 wherein the second conveyor section further comprises a plurality of fixed supports longitudinally spaced from the rolling support, the plurality of fixed supports secured along the pair of spaced beams and configured to frictionally engage the rails of each beam of the pair of beams of the first conveyor section.

10. The stackable conveyor system of claim 9 wherein the second conveyor section further comprises a projecting member extending from the second end of the second conveyor section, the projecting member configured for engagement with a lifting device.

11. The stackable conveyor system of claim 8 wherein the cross support is spaced from the first end of the second conveyor section.

12. The stackable conveyor system of claim 8 wherein the rolling support further comprises a first roller assembly and a second roller assembly, each of the first and second roller assemblies comprising:
a pair of spaced plates;
a cylindrical pivot bushing secured between the pair of plates, the pivot bushing being positioned over one of the first and second ends of the axle;
a pair of rollers spaced from the cylindrical bushing and rotationally connected between the pair of plates.

13. The stackable conveyor system of claim 12 wherein each roller of the pair of rollers has a width that is less than a spacing of the pair of plates.

14. The stackable conveyor system of claim 13 wherein the first roller assembly further comprises spacers between the pair of rollers and each plate of the pair of plates, the spacers centering each roller of the pair of rollers between the pair of plates.

15. The rolling support of claim 12 wherein each roller of the first and second roller assemblies is configured with a circumferential groove.

16. The rolling support of claim 12 wherein the first and second roller assemblies further comprise a stop member connected to a first plate of each pair of plates and extending toward the pair of rollers, wherein the rollers are positioned between the cylindrical bushing and the stop member.

17. A method of assembling an elongate conveyor system comprising:
providing a first conveying section having first end, a second end and a frame, the frame of the first conveying section supporting an endless belt conveying system, wherein the frame comprises first and second elongate beams each of which is configured with a rail.
providing a second conveying section having a frame, the frame of the second conveying section supporting an endless belt conveying system,
stacking the second conveying section atop the first conveying section with a first end of the frame of the second conveying section generally adjacent to the first end of the first conveying section, the first end of the frame of the second conveying section being frictionally supported on a first portion of the rails, and a second end of the frame of the second conveying section moveably supported by rollers on a second portion of the rails;
elevating the first end of the second conveying section until the second conveying section is supported on the rails only by the rollers;
rolling the second end of the second conveying section along the rails until the second end of the second conveying section is generally adjacent to the first end of the first conveying section; and
supporting the first end of the second conveying section on the ground.

18. The method of claim 17 wherein the step of rolling the second end of the conveying section comprises spacing the second end of the second conveying section from the first end of the first conveying section such that an end portion of the first conveying section is beneath the second end of the second conveying section.
